(19) United States
(12) Patent Application Publication
(10) Pub. No.: US 2009/0021686 A1
(43) Pub. Date: Jan. 22, 2009

(54) METHOD FOR GRAVURE PRINTING TRANSPARENT ELECTRODES, AN DINK COMPOSITION THEREFOR

(75) Inventors: Arie R. Van Doorn, Zaltbommel (NL); Wouter Maessen, Dubendorf (CH)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,845

(22) PCT Filed: Jan. 4, 2005
(86) PCT No.: PCT/IB2005/050024

§ 371 Date: Jun. 27, 2006

(30) Foreign Application Priority Data
Jan. 6, 2004 (GB) 0400107.9

(51) Int. Cl. G02F 1/1333; B41M 1/10; C09D 11/02

(52) U.S. Cl. 349/158; 101/170; 106/31.92

(57) ABSTRACT

A method of forming transparent electrodes on a substrate (19) is disclosed. The method comprises the steps of: depositing a patterned layer of a thermally decomposable ink composition (29) on a substrate by gravure offset printing, the thermally decomposable ink composition comprising an electrically conductive metal oxide having a particle size of less than the wavelength of visible light, a nitrocellulose binder, an alcohol solvent and an organic co-solvent having a boiling point of more than 250° C.; and thermally decomposing the thermally decomposable ink composition.

This invention relates to a method of forming transparent electrodes on a substrate. More particularly, this invention relates to a method of forming transparent electrodes on a substrate by gravure offset printing.

This invention also relates to a thermally decomposable gravure offset printing ink composition for use in forming transparent electrodes on a substrate, and a substrate having transparent electrodes formed by depositing the composition on a substrate by gravure offset printing.

Display devices such as liquid crystal display (LCD) devices and plasma display panels (PDPs) comprise transparent substrates on which are formed transparent conductive electrodes.

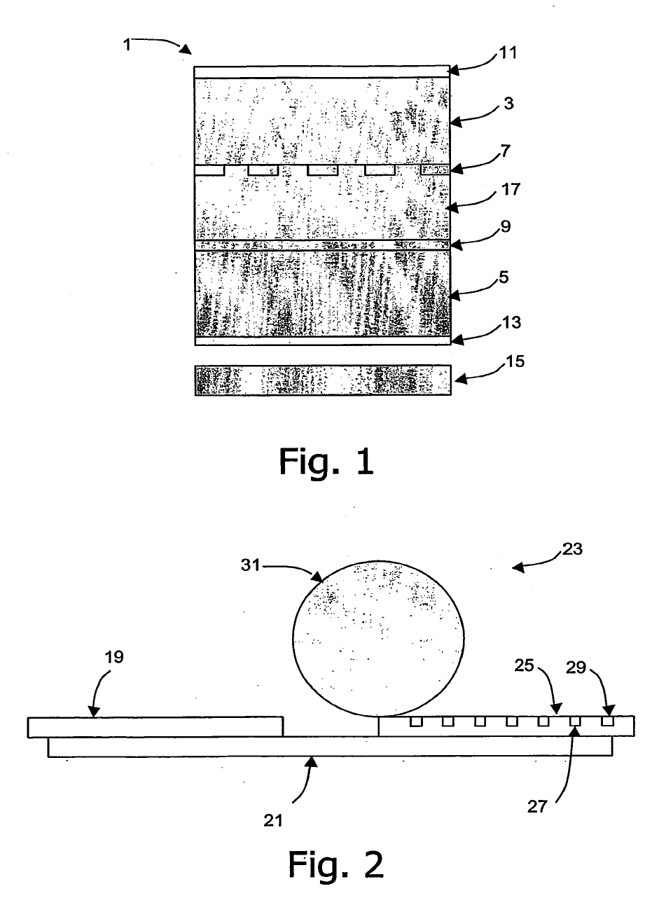

By way of example, a known passive matrix LCD device is schematically shown, in section, in FIG. 1. Referring to the Figure, the device 1 comprises parallel first and second transparent glass substrates 3, 5. The inner surface of the first substrate 3 is provided with an array of transparent electrodes 7 arranged as rows, and the inner surface of the second substrate 5 is provided with an array of transparent electrodes 9 arranged as columns. The row and column electrodes 7, 9 comprise indium tin oxide (ITO), which is indium doped tin oxide that is conductive and transparent. The ITO has a particle size of less than the wavelength of visible light.

The device also comprises parallel light polarizing films 11, 13 disposed on the outer surfaces of the substrates 3, 5 and a backlight 15 adjacent one of the substrates.

The row and column electrodes 7, 9 together define a matrix of regularly spaced pixels. Each pixel comprises a stack of liquid crystals 17 aligned between the substrates 3, 5.

In use, a pixel does not normally transmit light from the backlight 15 because the liquid crystals 17 in the pixel rotate the polarized light through an angle, which polarized light is then absorbed by the polarizing film 13.

However, when a voltage is applied to both the row and column electrodes 7, 9 of a pixel, the liquid crystals 17 in the pixel do not rotate the polarized light, and the polarizing film 13 transmits the polarized light.

Thus, an image is generated on the device 1 by sequentially applying a voltage to the row and column electrodes 7, 9 of a number of the pixels, which then transmit light that is incident from the backlight. The generated image may then be observed from in front of the substrate 5.

The above description relates to the structure and operation of a passive monochrome LCD device. The structure and operation of a colour LCD device is similar, except that each pixel comprises three stacks of liquid crystals associated with respective red, green and blue filters, each stack 6f liquid crystals is addressed by separate row or column electrodes. The structure and operation of an active matrix LCD device is also similar, except that each pixel also comprises switching circuitry, normally including a thin film transistor and a capacitor.

It is apparent from the above description that the substrates and at least some of the electrodes used in display devices must be transparent to ensure that they consistently transmit sufficient light to generate a high quality image. It is also apparent that high resolution display devices must have transparent electrodes having a correspondingly high resolution and accuracy.

Known methods of manufacturing transparent substrates having transparent electrodes having a high resolution and accuracy involve photolithography.

By way of example, the steps of one such known manufacturing method will be described. Firstly, a thin film of ITO is deposited on a transparent glass substrate by sputtering. Secondly, a layer of photoresist polymer is deposited on top of the ITO film. Thirdly, a mask having a pattern representative of the desired electrode layout is placed above the photoresist layer and ultraviolet (UV) light is shone through the mask. Fourthly, the photoresist layer is developed to remove areas that have been weakened by exposure to the UV light. Fifthly, exposed areas of the ITO are chemically etched to leave only the areas of ITO that are covered in photoresist. Finally, the photoresist is removed from the remaining areas of ITO to leave the desired transparent electrode pattern.

Although the known method described above provides transparent electrodes having a high resolution and accuracy, it has a number of drawbacks. Firstly, the large number of steps involved makes it time consuming and expensive. Secondly, the steps of depositing an ITO film and etching the ITO film make the method inherently inefficient. Thirdly, the etching process generates a large quantity of liquid waste, which is environmentally undesirable.

U.S. Pat. No. 5,421,926 and U.S. Pat. No. 6,274,412 disclose methods of printing ITO electrodes onto a transparent substrate. However, the ink is tailored for screen printing, and the electrodes are therefore prone to distortion. Accordingly, the method is not able to provide transparent electrodes having the high resolution and accuracy demanded by modern display device applications.

U.S. Pat. No. 5,312,643 discloses a method of gravure offset printing ITO electrodes onto a transparent substrate. The electrodes are deposited on the transparent substrate as a mixture of indium 2-ethylhexanoate, tin p-toluilate and butyl carbitol acetate (so-called resinate ITO), which is then heated at a high temperature (580° C.) to form ITO. This high temperature thermal decomposition process renders the method unsuitable for use in the manufacture of most display devices as it may adversely affect other layers disposed on the substrate, such as thin film transistors of an active matrix display device. Secondly, the method may provide transparent electrodes having insufficient electrical conductivity, thus requiring the deposition of additional metal electrodes. Such additional complexity increases manufacturing costs.

According to an aspect of the invention, there is provided a method of forming transparent electrodes on a substrate, the method comprising the steps of: depositing a patterned layer of a thermally decomposable ink composition on a substrate by gravure offset printing, the thermally decomposable ink composition comprising an electrically conductive metal oxide having a particle size of less than the wavelength of visible light, a nitrocellulose binder, an alcohol solvent and an organic co-solvent having a boiling point of more than 250° C.; and heating the thermally decomposable ink composition. Heating the thermally decomposable ink composition preferably comprises thermally decomposing the thermally decomposable ink composition.

Compared to known techniques involving photolithography, forming transparent electrodes by printing is a simple process that may lead to cost savings. It is also inherently more efficient and more environmental acceptable since no deposited material is etched away. The previous problems associated with printing transparent electrodes have also been overcome. In particular, it has been found that a gravure offset printing technique, using a suspension of electrically conductive metal oxide particles, is capable of providing transparent electrodes having the high resolution, accuracy and feature quality necessary for modern display device applications. This is because, unlike other printing techniques such as screen printing and conventional and waterless/dry offset printing, gravure offset printing is characterised by the combination of almost complete transfer of printing ink to the substrate, a high graphic quality and very low short and long range distortion. The specific thermally decomposable ink composition allows lower temperature thermal decomposition, which renders the method suitable for use in the manufacture of most display devices, since the thermal stresses on other layers that may be disposed on the substrate are minimised.

The metal oxide concentration and an rheology may be adjusted using methods that will be well know to persons skilled in the art. For example, this may be achieved by varying the respective proportions of metal oxide, solvent and binder. The metal oxide concentration affects the thickness of the transparent electrodes after thermal decomposition. The rheology affects flow and splitting during pick-up and/or print-down, and thus affects resolution, print quality and accuracy during the printing process.

It has been found that alcohol solvents hold stable dispersions of metal oxide particles. It has also been found that nitrocellulose polymers are compatible with alcohol solvents.

It has also been found that the use of a co-solvent facilitates the transfer of almost all of the ink from a transfer blanket to the substrate during printing, thus resulting in higher print quality. This is because instead of splitting, full transfer from blanket to substrate takes place, thus resulting in straighter edges, less pinholes and a smoother printed surface. It has been found that co-solvents having boiling points greater than 250° C. are most effective.

The metal oxide particles preferably have an average diameter of less than 0.1 μm, and preferably a maximum diameter of less than 0.3 μm. More preferably, the metal oxide particles have an average particle size in the range 3 nm to 80 nm. The metal oxide particles are preferably indium doped tin oxide particles. Compositions comprising such particles have been found to result in high quality and highly-accurate transparent electrodes.

The boiling point of the solvent may be no more than 250° C. The boiling point of the solvent is preferably no more than 150° C., more preferably no more than 100° C., and most preferably no more than 50° C. The solvent is preferably at least one of an alkylalcohol, a monoalkyl ethyleneglycol and a monoalkyl propyleneglycol. The solvent is more preferably isopropoxyethanol.

The organic co-solvent is preferably at least one of an acetate, an alkylalcohol, an ester, a mono or dialkyl ether of an ethyleneglycol and a mono or dialkyl ether of a propyleneglycol. The organic co-solvent is more preferably at least one of tri propylene glycol and tetra ethylene glycol.

Preferably, the method further comprises the step of homogenising the thermally decomposable ink composition prior to the step of depositing the patterned layer of the thermally decomposable ink composition. This ensures an even dispersion of particles and a homogeneous binder concentration within the composition, and ensures high quality transparent electrodes.

The step of depositing the patterned layer of the thermally decomposable ink composition preferably comprises the steps of: filling patterned grooves in the surface of a cliché with the thermally decomposable ink composition; transferring the thermally decomposable ink composition from the patterned grooves to the surface of a blanket by bringing the blanket into contact with the surface the cliché; and transferring the thermally decomposable ink composition from the surface of the blanket to the surface of the substrate by bringing the blanket in to contact with the surface of the substrate. Such steps have been found to provide high print quality with low distortion.

The step of thermally decomposing the thermally decomposable ink composition, which is required to obtain transparent electrodes having a high electrical conductivity, preferably comprises firing the decomposable ink composition at a temperature of no more than 400° C., more preferably at a temperature of no more than 300° C., and most preferably at a temperature in the range 250° C. to 300° C., in the presence of oxygen, for example in an air or pure oxygen atmosphere. Such a temperature is lower than those used in known methods of forming transparent metal oxide electrodes by printing, and thus results in reduced thermal stresses and allows processing on standard substrates.

The step of thermally decomposing the thermally decomposable ink composition may specifically comprise the steps of: firing the thermally decomposable ink composition in an air atmosphere at a temperature in the range 200° C. to 400° C. for at least 50 minutes; and firing the thermally decomposable ink composition in a reducing atmosphere of 7% hydrogen in nitrogen at a temperature in the range 200° C. to 400° C. for at least 50 minutes.

The thermally decomposable ink composition may alternatively be fired at a higher temperature of up to 550° C. in the presence of oxygen. Such a higher temperature provides transparent electrodes having a slightly higher electrical conductivity. Because such a higher temperature involves significantly greater thermal stresses, the lower firing temperatures are preferred.

If a higher firing temperature is used, the step of thermally decomposing the thermally decomposable ink composition may specifically comprise the steps of: firing the thermally decomposable ink composition in an air atmosphere at a temperature in the range 500° C. to 550° C. for at least 50 minutes; and firing the thermally decomposable ink composition in a nitrogen atmosphere (<5 ppm oxygen) at a temperature in the range 500° C. to 550° C. for at least 50 minutes.

The firing processes described above have been found to be effective in forming high quality transparent electrodes.

In applications where thermal stresses must be minimised, for example display devices having flexible substrates, the thermally decomposable ink composition may simply be dried, preferably at a temperature in the range 110° C. to 130° C. Such a drying process provides transparent electrodes having a moderate conductivity. However, in general, firing of the thermally decomposable ink composition is preferred because it provides transparent electrodes having a high conductivity.

According to another aspect of the invention, there is provided a thermally decomposable gravure offset printing ink composition for use in forming transparent electrodes on a substrate, comprising: an electrically conductive metal oxide having a particle size of less than the wavelength of visible light; a nitrocellulose binder; an alcohol solvent; and an organic co-solvent having a boiling point of more than 250° C.

The electrically conductive metal oxide preferably has an average particle size of less than 0.1 μm, and more preferably in the range 3 nm to 80 nm. The electrically conductive metal oxide is preferably indium doped tin oxide.

The solvent preferably comprises a polar and relatively moderately evaporating alcohol. The boiling point of the solvent may be no more than 250° C. The boiling point of the solvent is preferably no more than 150° C., more preferably no more than 100° C., and most preferably no more than 50° C. Exemplary classes of suitable solvents include alkylalcohols, monoalkyl ethyleneglycols and monoalkyl propyleneglycols. The solvent more preferably comprises isopropoxyethanol.

The organic co-solvent preferably comprises at least one of an acetate, an alkylalcohol, an ester, a mono or dialkyl ether of an ethyleneglycol and a mono or dialkyl ether of a propyleneglycol. The organic co-solvent more preferably comprises at least one of tri propylene glycol and tetra ethylene glycol.

The nitrocellulose binder may contain from 10.7 to 12.6 wt % nitrogen, and preferably contains from 10.9 to 11.3 wt % nitrogen. The nitrocellulose binder preferably has a Cochius viscosity (sec) of between 30 and 34 for 12 wt % in butanol, ethyl glycol, toluene and ethanol (the butanol, ethyl glycol, toluene and ethanol being in the ratio 1:2:3:4). For example, the nitrocellulose binder is preferably nitrocellulose A400, A500, E740, E950, E1440, and preferably nitrocellulose A500, all supplied by Walsrode.

The electrically conductive metal oxide particles are preferably 15 to 25 wt % of the composition. The solvent is preferably 45 to 60 wt % of the composition. The co-solvent is preferably 5 to 15 wt % of the composition. The decomposable binder is preferably 15 to 25 wt % of the composition. It has been found that compositions formulated in this way have an optimal metal oxide concentration and an optimal rheology.

The invention also provides a substrate having transparent electrodes formed by: depositing a patterned layer of the composition described above on a substrate by gravure offset printing; and heating the composition to form the transparent electrodes.

For a better understanding of the above features and advantages of the invention, embodiments will now be described, purely by way of example, with reference to the accompanying drawings in which:

FIG. 1 schematically shows a known LCD device, in section;

FIG. 2 schematically shows a method of forming transparent electrodes on a substrate according to the invention;

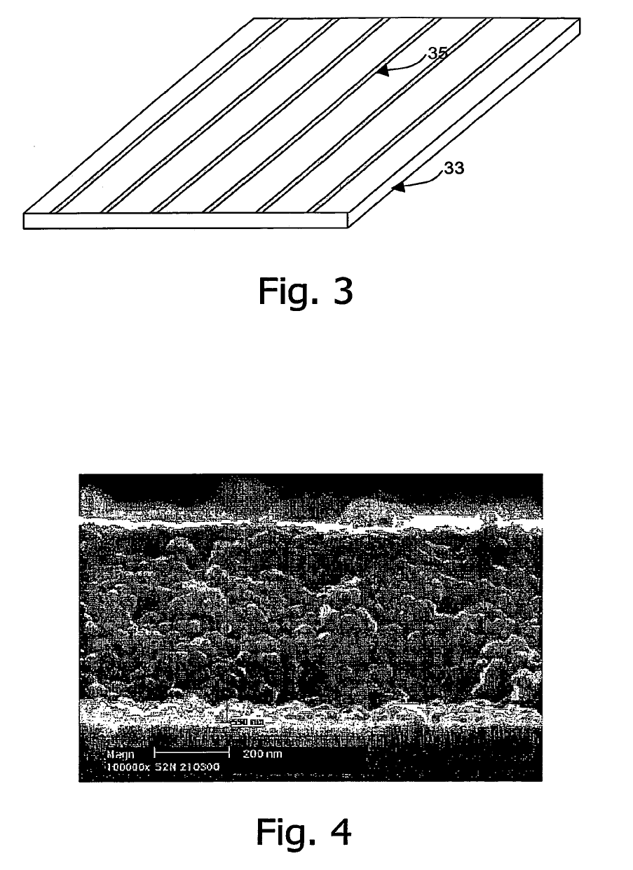

FIG. 3 schematically shows a substrate having transparent electrodes according to the invention; and

FIG. 4 is a microscopic image of a cross section of a substrate having transparent electrodes according to the invention.

Preparation of a thermally decomposable gravure offset printing ink composition for use in forming transparent electrodes on a substrate according to the invention will first be described.

1.59 g of tri propylene glycol (TPG) are added to 8.06 g of 2-isopropoxy ethanol (IPE) containing 40 wt % nitrocellulose binder. The nitrocellulose binder contains between 10.9 and 11.3 wt % nitrogen, and has a Cochius viscosity (sec) of between 30 and 34 for 12 wt % in butanol, ethyl glycol, toluene and ethanol (the butanol, ethyl glycol, toluene and ethanol being in the ratio 1:2:3:4). The nitrocellulose binder may, for example, be nitrocellulose A500 supplied by Walsrode.

This mixture is then mechanically homogenised by processing on a three-roll-mill for at least 12 hours. 8.02 g of 43 wt % indium tin oxide dispersion in IPE are then added to the mixture. The indium tin oxide particles have an average diameter of 25 nm. The resulting mixture is mechanically homogenised by thorough mixing with a spatula. The mixture is further homogenised by processing on a three-roll-mill for 5 hours.

A method of forming transparent electrodes on a substrate using the above composition according to the invention will now be described with reference to FIG. 2.

Referring to the Figure, a glass substrate 19 is first cleaned in fuming nitric acid before being placed on a platform 21 of a gravure offset printing apparatus 23. The glass substrate has a thickness of 0.7 mm.

A polymer cliché 25 is also placed on the platform 21 of the gravure offset printing apparatus 23. The surface of the polymer cliché 25 contains grooves 27 to a depth of 20 μm that represent the desired pattern of transparent electrodes to be formed on the substrate 19. Electroformed printing plates may be used in alternative embodiments. The grooves 27 in the surface of the polymer cliché 25 are filled with the thermally decomposable gravure offset printing ink composition 29 described above. The grooves 27 are filled using a thin steel doctoring blade travelling across the cliché at a surface speed of 0.1 m/s under an indentation of 0.1 mm.

The gravure offset printing apparatus 23 is fitted with a transfer blanket 31. The transfer blanket 31 has a silicone top layer having an increased smoothness compared to that of standard blankets. A fill may also be applied on the blanket cylinder before the blanket is mounted in order to provide an optimal blanket diameter.

Once the gravure offset printing apparatus 23 has been set up as described above, the thermally decomposable gravure offset printing ink composition 29 is printed onto the glass substrate 19 as described below.

The transfer blanket 31 is first rolled across the surface of the polymer cliché 25 so that the thermally decomposable gravure offset printing ink composition 29 in the grooves 27 is transferred to the surface of the transfer blanket 31. The transfer blanket 31 is rolled across the surface of the polymer cliché 25, for example, at a surface speed of 0.1 m/s under a transfer blanket indentation of 0.25 mm.

Once the thermally decomposable gravure offset printing ink composition 29 has been transferred to the surface of the transfer blanket 31, the transfer blanket 31 is moved towards the glass substrate 19. The transfer blanket 31 is then rolled across the surface of the glass substrate 19 so that the thermally decomposable gravure offset printing ink composition 29 is transferred to the surface of the glass substrate 19. The transfer blanket 31 is rolled across the surface of glass substrate 19, for example, at a surface speed of 0.1 m/s under a transfer blanket indentation of 0.1 mm.

The specific printing process and ink composition used result in almost all of the thermally decomposable gravure offset printing ink composition being transferred from the grooves in the surface of the cliché to the glass substrate, thus ensuring a highly accurate print process with high resolution and feature quality.

Once the thermally decomposable gravure offset printing ink composition has been printed onto the glass substrate, the glass substrate is fired to thermally decompose the thermally decomposable gravure offset printing ink composition. Thermal decomposition causes the tri propylene glycol (TPG), the isopropoxy ethanol (IPE) and the nitrocellulose polymer binder to decompose and/or evaporate, leaving only the transparent indium tin oxide particles deposited on the surface of the glass substrate.

The glass substrate is first fired for 28 minutes in an air atmosphere at a temperature ramping up from 20° C. to 300° C., followed by 60 minutes in the air atmosphere at 300° C. The glass substrate is then fired for 60 minutes in a reducing atmosphere of 7% hydrogen in nitrogen at 300° C., followed by 28 minutes in the reducing atmosphere at a temperature ramping down from 300° C. to 20° C.

FIG. 3 schematically shows a substrate 33 having transparent electrodes 35 that has been prepared according to the above method.

Straight transparent electrodes lines are shown, and it has been found that straight transparent electrode lines having widths of 235 μm, 120 μm and 88 μm all have straight edges, thus indicating high accuracy, feature quality and resolution. The number of pinhole defects in the transparent electrodes has been observed to be minimal. The transparent electrodes also exhibited high transparency, low optical haze and high electrical conductivity.

The transparent substrate having transparent electrodes according to the invention has been assembled into a passive monochrome LCD device. Images generated by the assembled device have been observed to be of a high quality.

FIG. 4 is a microscopic image of a cross section of a substrate having transparent electrodes according to the invention. It can be seen from FIG. 4 that pore size is very small, thus preventing optical scattering, and consequently providing high optical transparency. This is characteristic of electrodes provided by the invention.

It is to be understood that this detailed description discloses specific embodiments of a broader invention and is not intended to be limiting. There are many other embodiments within the scope of the invention as claimed hereafter, and these will be apparent to those skilled in the art.

For example, the exemplary method described above is devised for forming transparent electrodes on substrates in low volumes under laboratory conditions. However, it will be understood that the invention may also be applied to high volume industrial processes, such as active matrix LCD device manufacture.

Although the exemplary method described above uses specific firing temperatures and times, it will be understood that a variety of other firing or drying temperatures and times are suitable.

The exemplary thermally decomposable gravure offset printing ink composition described above comprises indium tin oxide. However, other conductive metal oxides are suitable. For example, the composition may comprise antimony tin oxide.

The exemplary substrate having transparent electrodes described above is for use in display devices. However, substrates according to the invention may be used in other applications where transparent electrodes are desirable, for example solar cells.

1. A method of forming transparent electrodes (35) on a substrate (33), the method comprising the steps of:
depositing a patterned layer of a thermally decomposable ink composition on a substrate by gravure offset printing, the thermally decomposable ink composition comprising an electrically conductive metal oxide having a particle size of less than the wavelength of visible light, a nitrocellulose binder, an alcohol solvent and an organic co-solvent having a boiling point of more than 250° C.; and
heating the thermally decomposable ink composition.

2. The method of claim 1, wherein heating the thermally decomposable ink composition comprises thermally decomposing the thermally decomposable ink composition.

3. The method of claim 1, wherein the electrically conductive metal oxide has an average particle size of less than 0.1 μm.

4. The method of claim 1, wherein the electrically conductive metal oxide has an average particle size in the range 3 nm to 80 nm.

5. The method of claim 1, wherein the electrically conductive metal oxide is indium doped tin oxide.

6. The method of claim 1, wherein the solvent comprises at least one of an alkylalcohol, a monoalkyl ethyleneglycol and a monoalkyl propyleneglycol.

7. The method of claim 1, wherein the solvent comprises isopropoxyethanol.

8. The method of claim 1, wherein the organic co-solvent comprises at least one of an acetate, an alkylalcohol, an ester, a mono or dialkyl ether of an ethyleneglycol and a mono or dialkyl ether of a propyleneglycol.

9. The method of claim 1, wherein the organic co-solvent comprises at least one of tri propylene glycol and tetra ethylene glycol.

10. The method of claim 1, further comprising the step of homogenising the thermally decomposable ink composition prior to the step of depositing the patterned layer of the thermally decomposable ink composition.

11. The method of claim 1, wherein the step of depositing the patterned layer of the thermally decomposable ink composition comprises the steps of:
filling patterned grooves in the surface of a cliché with the thermally decomposable ink composition;
transferring the thermally decomposable ink composition from the patterned grooves to the surface of a blanket by bringing the blanket in to contact with the surface the cliché; and
transferring the thermally decomposable ink composition from the surface of the blanket to the surface of the substrate by bringing the blanket in to contact with the surface of the substrate.

12. The method of claim 1, wherein the step of heating the thermally decomposable ink composition comprises firing the thermally decomposable ink composition at a temperature of no more than 400° C. in the presence of oxygen.

13. The method of claim 1, wherein the step of heating the thermally decomposable ink composition comprises the steps of:
firing the thermally decomposable ink composition in an air atmosphere at a temperature in the range 200° C. to 400° C. for at least 50 minutes; and
firing the thermally decomposable ink composition in a reducing atmosphere of hydrogen and nitrogen at a temperature in the range 200° C. to 400° C. for at least 50 minutes.

14. A thermally decomposable gravure offset printing ink composition for use in forming transparent electrodes (35) on a substrate (33), comprising:
an electrically conductive metal oxide having a particle size of less than the wavelength of visible light;
a nitrocellulose binder;
an alcohol solvent; and
an organic co-solvent having a boiling point of more than 250° C.

15. The composition of claim 14, wherein the electrically conductive metal oxide has an average particle size of less than 0.1 μm.

16. The composition of claim 14, wherein the electrically conductive metal oxide has an average particle size in the range 3 nm to 80 nm.

17. The composition of claim 14, wherein the electrically conductive metal oxide is indium doped tin oxide.

18. The composition of claim 14, wherein the nitrocellulose binder contains from 10.9 to 11.3 wt % nitrogen.

19. The composition of claim 14, wherein the solvent comprises at least one of an alkylalcohol, a monoalkyl ethyleneglycol and a monoalkyl propyleneglycol.

20. The composition of claim 14, wherein the solvent comprises isopropoxyethanol.

21. The composition of claim 14, wherein the organic co-solvent comprises at least one of an acetate, an alkylalcohol, an ester, a mono or dialkyl ether of an ethyleneglycol and a mono or dialkyl ether of a propyleneglycol.

22. The composition of claim 14, wherein the organic co-solvent comprises at least one of tri propylene glycol and tetra ethylene glycol.

23. The composition of claim 14, wherein the electrically conductive metal oxide is 15 to 25 wt % of the composition.

24. The composition of claim 14, wherein the nitrocellulose binder is 15 to 25 wt % of the composition.

25. The composition of claim 14, wherein the solvent is 45 to 60 wt % of the composition.

26. The composition of claim 14, wherein the organic co-solvent is 5 to 15 wt % of the composition.

27. A substrate (33) having transparent electrodes (35) formed by:
depositing a patterned layer of the composition of claim 14 on a substrate by gravure offset printing; and
heating the composition to form the transparent electrodes.

28. The substrate of claim 27, wherein heating the composition comprises thermally decomposing the composition.
